(19) United States
(12) Patent Application Publication
(10) Pub. No.: US 2006/0098781 A1
(43) Pub. Date: May 11, 2006

(54) Method and apparatus for nanoscale surface analysis using soft X-rays

(75) Inventors: Scott H. Bloom, Encinitas, CA (US); Oscar Hemberg, La Jolla, CA (US)

Correspondence Address: BAKER & MCKENZIE LLP;PATENT DEPARTMENT, 2001 ROSS AVENUE, SUITE 2300, DALLAS, TX, 75201, US

(73) Assignee: JMAR Research, Inc.

(21) Appl. No.: 11/300,552

(22) Filed: Dec. 14, 2005

Related U.S. Application Data
(63) Continuation-in-part of application No. 10/907,321, filed on Mar. 29, 2005.
(60) Provisional application No. 60/557,364, filed on Mar. 29, 2004.

(51) Int. Cl. H05G 2/00; G21G 4/00; H01J 35/00

(52) U.S. Cl. 378/119

(57) ABSTRACT

A nano-scale surface analysis system comprises an electrically powered apparatus for the generation of soft x-ray laser radiation. The apparatus comprises an excitation circuit having at least two or more electrically conducting structures separated by a liquid dielectric for providing a high current excitation pulse, and a capillary structure having a capillary with a length to diameter ration of about 20 to 1000 for enclosing a selected lasing material, wherein the excitation circuit is capable of generating a plasma volume within the capillary structure to produce a population inversion. The generator further comprises a focusing optic for receiving the soft x-ray radiation from the emissions source and focus the soft x-ray radiation onto a target for forming a nanoplasma, the soft x-ray radiation being focused onto an area of the target having a diameter of less than 100 nm.

### CROSS-REFERENCE TO RELATED APPLICATIONS

This application is a continuation-in-part of U.S. Utility application Ser. No. 10/907,321 entitled “Morphology and Spectroscopy of Nanoscale Regions Using X-Rays Generated by Laser Produces Plasma,” filed Mar. 29, 2005, which claims priority to U.S. Provisional Application No. 60/557,364, entitled “Nanometer Surface Ablation for Micro-Plasma Spectrometry,” filed Mar. 29, 2004, the entire contents of which is hereby incorporated by reference.

### BACKGROUND

1. Field of the Invention

This disclosure relates to techniques and apparatuses for small spot size illumination on a target for nano-scale surface analysis, including materials analysis, nanomachining, and nano-scale chemical vapor deposition.

2. Background of the Invention

Nanoscale materials, in particular materials that have spatial chemical variations on the nanometer scale, are currently being aggressively pursued by a variety of research and development groups. Applications of these materials are wide ranging and potentially revolutionary. In order to develop such materials, diagnostic techniques capable of producing accurate and sensitive chemical analysis on the spatial scale of the nanomaterial itself are required. There are currently many materials analysis techniques available to look at surfaces and interfaces; most use a spectrometer looking at emitted radiation, emitted photoelectrons, or emitted ions from the material under analysis. While these techniques are quite reliable and sensitive, they currently do not have the capability to analyze materials, particularly in-situ, on the spatial scales required for nano technology.

Current optical techniques for materials and surface analysis are generally limited by diffraction to sample spatial resolutions greater than 200 nm whereas it is projected that the spatial frequencies needing to be sampled for new materials will be in the 20-200 nm range. There are some techniques available for probing materials at such resolutions, usually based on atomic force microscopy (AFM), near-field scanning optical microscopy (NSOM) techniques, or SEM/TEM, {put in words}which are in general somewhat slow and tedious to use since the probe is nearly in contact with the sample. A radiation-based mechanism permits non-contact sample interaction that usually translates into increased speed or area examined.

One technique for obtaining sample spectrochemistry is laser-induced breakdown spectroscopy (LIBS), where a laser beam is tightly focused to a sample and forms a plasma. Emission spectra from the plasma are collected and run into a spectrometer where various chemicals can be identified based on the positions of peaks on the recorded spectrum. For nanoscale materials, physics imposes a limit on the smallest size spot at which a laser can be focused, about 1.22× the wavelength of the laser. Therefore, even for a 193 nm excimer laser, the smallest obtainable sample size is about 200 nm. This resolution is not high enough to examine nanomaterials that are expected to have chemical variations below the 200 nm scale.

### SUMMARY

A nanoplasma technique is disclosed for analyzing the properties of a material on a nanoscale using laser-produced plasma x-rays. Soft x-rays have wavelengths in the range of 1-50 nm and therefore the diffraction-limited spot size of focused x-rays can be as small as 1.22× the radiation wavelength, or less than 20 nm spot size.

In one aspect, an x-ray source is disclosed that is bright enough that when focused to a 10-30 nm spot size will deliver enough power per unit area to form a nanoplasma. A soft x-ray source has demonstrated more than 20 W of x-ray power into 2πsr. Focusing a small collected solid angle of this x-ray radiation is more than enough power to form a very hot plasma that emits a range of radiation from UV through IR that can be collected and analyzed on an optical spectrometer.

Since the radiation used to form the plasma is soft x-rays, for example as opposed to UV from a laser, the focused spot size is much smaller in diameter and therefore suitable for studying materials at nanoscale spatial resolutions.

Optionally, ions ablated by the nanoplasma can be swept from the region of interest using electromagnetic fields into a time-of-flight mass spectrometer that could give additional information about the material, still at nanoscale spatial resolution, not available in the emitted radiation.

In one aspect, soft x-ray radiation suitable for this application is available from a laser-produced plasma source.

In another aspect, soft x-ray radiation suitable for this application is available from a soft x-ray laser.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a diagram illustrating an example system configured to generate and focus soft x-rays onto a very small spot size on a target in order to generate a nanoplasma in accordance with one embodiment;

FIG. 2 is a diagram illustrating an example system configured to generate and focus soft x-rays onto a very small spot size on a target, wherein the emissions source for the soft x-rays is a soft x-ray laser;

FIG. 3 is a diagram illustrating an example embodiment of a soft x-ray laser that can be used in the system of FIG. 2;

FIG. 4 a diagram illustrating an example system configured to generate and focus soft x-rays onto a very small spot size on a target, wherein the soft x-ray emissions source uses a laser-produced plasma x-ray source;

FIG. 5 a diagram illustrating a first embodiment of an x-ray nanoplasma spectroscopy system;

FIG. 6 a diagram illustrating a second embodiment of an x-ray nanoplasma spectroscopy system;

FIG. 7 a diagram illustrating a third embodiment of an x-ray nanoplasma spectroscopy system; and

FIG. 8 a diagram illustrating a fourth embodiment of an x-ray nanoplasma spectroscopy system.

### DETAILED DESCRIPTION OF THE PREFERRED EMBODIMENTS

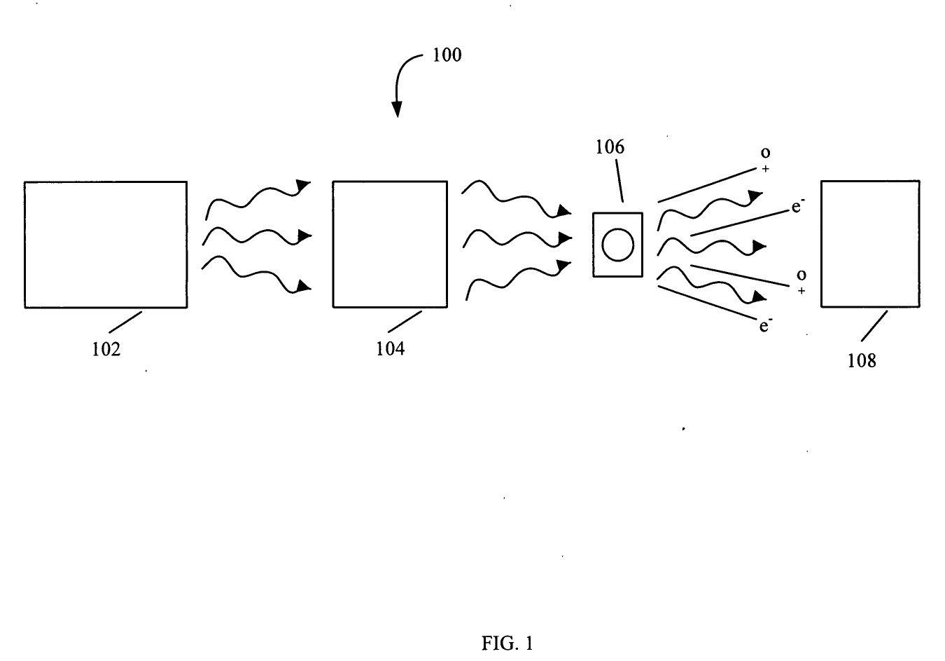

Disclosed herein is a system and method for performing nanoscale surface analysis of a sample. As shown in FIG. 1, an exemplary system 100 configured in accordance with the systems and methods described herein generally comprises an emissions source 102, an emissions optical system 104 for collecting and/or directing the emissions, a target sample 106 that forms a plasma when irradiated with the emissions, and analysis instrumentation 108 for analyzing radiation emitted from the plasma.

Unlike conventional systems, system 100 is capable of generating spot size under 200 nm and, even well under 100 nm. For example, emissions source 102 is capable of generating soft x-rays with wavelengths in ranges as low as 1-15 nm. It will be understood, however, that matching the right optic, or optical system 104 with emissions source 102 is also critical for achieving the desired spot size. Thus, it will be understood that any emissions source cable of generating soft x-rays of the appropriate wavelength can be used in accordance with the system sand methods described herein. For example, in certain embodiments described below, emission source 102 comprises a soft x-ray laser. In other embodiments, emission source 102 comprises a laser system as an energy source and a target material as a radiation source. Each type of embodiment can further comprise special optics 104 selected and designed to produce the desired spot size when paired with a particular emissions source 102. It will be understood, however, that any optical system 104 can be used in conjunction with the appropriate emissions source 102 in order to produce the desired spot size.

Accordingly, several embodiments and implementations are described below; however, the particular descriptions should not be seen as limiting the systems and methods described herein to any particular embodiment or implementation.

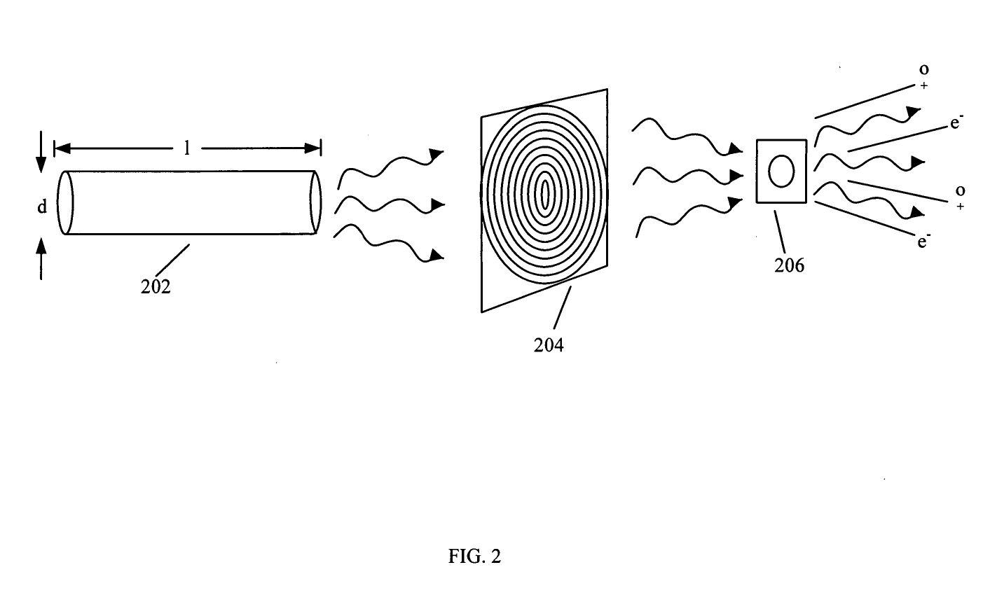

FIG. 2 is a diagram illustrating an example embodiment of a system 200 configured to perform nanoscale surface analysis of a sample that uses a soft x-ray laser 202 as the emissions source. Soft x-rays produced by soft x-ray laser 202 can be collected by optic, or optical system 204, which can be configured to focus the soft x-rays onto a target 206. As mentioned above, optic 204 can be selected in order to produce the desired spot size on target 206 in combination with soft x-ray laser 202.

It will be understood that many soft x-ray lasers use a capillary to produce the soft x-rays. A typical capillary included in a soft x-ray laser will have a diameter (d) of a few millimeters, e.g., approximately 200 microns. Achieving the correct spot size is at least partially dependent on achieving the correct coherence and gain with soft x-ray laser 202. The coherence and gain can be manipulated by manipulating the length (l) of a capillary included in soft x-ray laser 202.

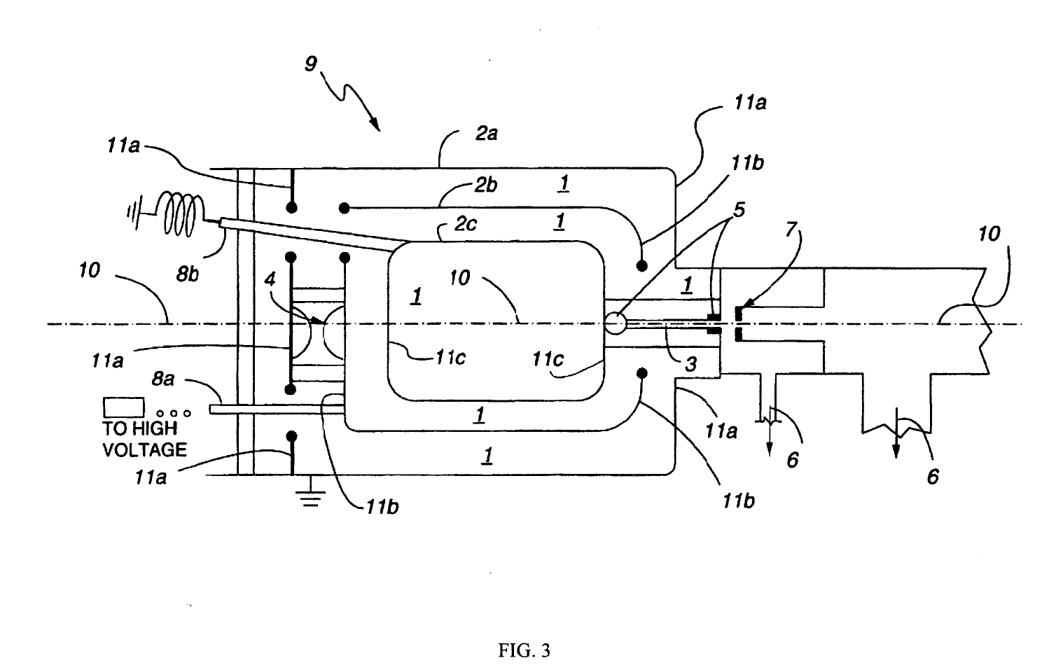

In certain embodiments, soft x-ray laser 202 can comprise a compact, discharged pump soft x-ray laser such as that described in U.S. Pat. No. 6,167,065, entitled “Compact Discharge Pump Soft X-Ray Laser,” issued to Jorge Rocca on Dec. 26, 2000 (the Rocca patent), which is incorporated herein by reference as it set forth in full. FIG. 1 of the Rocca patent has been reproduced herein as FIG. 3.

Thus, FIG. 3 is a diagram illustrating a simplified diagram of the cross section of a soft x-ray laser that can be used as an excitation source in accordance with one embodiment of the systems and methods described herein. As can be seen, the laser of FIG. 3 is powered by a transmission line 9 that has in its central part a cylindrical geometry that is a combination of cylindrical tubes 2a, 2b and 2c that are concentric about a certain axis 10 and have end disks 11a, 11b and 11c, respectively. The space between tubes 2a, 2b, and 2c is substantially filled with a liquid dielectric 1, e.g., water or ethylene glycol. The three concentric tubes 2a, 2b, and 2c are made of metal such as stainless steel, brass, or copper, so that these tubes form a transmission line that is configured as a Blumlein or modified Blumlein configuration. The Blumlein or modified Blumlein configuration can be referred to collectively as configuration 2.

Note that the outer tube 2a is also used to contain the liquid dielectric 1 of the transmission line 9. Also note that the elements 8a and 8b are electrical connections linking the transmission line to the high voltage power supply 8a used to charge the transmission line and to ground 8b.

Capillary 3 is preferably partially embedded in transmission line 9 to help reduce inductance. Thus, capillary 3 is surrounded by liquid dielectric 1. Outside conducting tube 2a is kept at ground potential. Middle conducting tube 2b is first charged to a high voltage, e.g., 0.5 to 500 kilovolts, by means of a high voltage power source (not shown) and is subsequently switched to ground by one or more fast spark-gap switches 4. The charging circuit used in conjunction with the high voltage power source is also not shown in FIG. 1; however, both are symbolically indicated by the label high voltage.

Note that the switch can be implemented using a gas filled spark-gap. Accordingly, in such an implementation, when the spark-gap breaks, the inner tube 2c is elevated to a high voltage and a large voltage difference, e.g., a difference within the range of 2 kilovolts to 10 megavolts, builds across capillary 3, which is connected between the inner and outer tubes by means of two electrodes 5. The voltage difference causes a fast, high current excitation pulse to flow through the capillary 3. Not shown on the diagram for simplicity are means to pre-ionize the discharge and to stop undesired current pre-pulses.

Following the excitation by this fast high current excitation pulse, the plasma volume compresses and creates a large number of ions and selected species excited to the laser upper level by collisional electron impact excitation. This generates a population inversion between the upper and the lower level of the laser transition. The spontaneous emission of the laser transition is amplified in and high intensity laser beam is formed as the radiation propagates through capillary 3. Although pressure is maintained by means of vacuum pump 6 and selected pin holes 7 at the exit of the device to avoid absorption of the laser radiation by residual gas or vapor.

It will be understood that several variations of these transmission line geometry are possible. For example, the switch can be placed between a middle tube and an inner tube. In any case, a fast high current pulse is produced at the capillary when the switch breaks. Also, the transmission line can be implemented with three parallel plates rather than three concentric cylinders. In another variation, the number of transmission lines can be larger than the two lines conformed by the three concentric tubes. Also as mentioned above, a half-optical cavity or full optical resonator, constituted by one or more reflecting surfaces, can be added to enhance the energy and intensity of the laser.

The electrodes are preferably provided with protrusions that protrude into the capillary structure in order that electrical breakdown occurs through the capillary and flash over is avoided in external surfaces. This can also be encouraged by making the distance that separates the electrodes through the capillary much shorter than any other external path that might connect it to electrodes. External flashover is also avoided by the liquid dielectric that surrounds the capillary.

Thus, embodiments using a soft x-ray laser, such as that illustrated in FIG. 3, employ a fast current pulse injected into a capillary channel in order to generate a plasma column with a large length to diameter ratio having adequate conditions for producing an intent soft x-ray output. The plasma can be generated by either injecting material in gases or vapor form in a capillary channel, or by a lazing material from the capillary walls. The necessary excitation for lazing at soft x-ray wavelengths can be produced, among other methods, by collusional electron impact excitation or by electron ion recombination.

Electron impact excitation comprises energetic electrons from laser created plasmas colliding with ions of a certain charged state. The energetic electrons excite the ions to create a population inversion between two excited levels of this specie. What follows as a result is common to the operation of most other lasers: the process of stimulated emission causes the radiation corresponding to the wavelength of the radiated transition that links the two levels to amplify and attempts to laze as it travels through the medium.

In embodiments that use electron impact excitation, neon-like or nickel-like ions can be generated and used as an amplification medium. Further, the fast current pulse can be used to excite argon gas injected into such capillary channels. It has been shown that argon can be ionized to the neon-like state by the current pulses and lazed at a wavelength in the range of 40-50 nanometers, e.g., approximately 46.9 nanometers, by collisional electron excitation of the laser upper levels.

Such a laser can produce a beam of quanta having an individual energy of about 10 times larger than visible light. In certain embodiments, a liquid dielectric capacitor, such as that described above, can be used to produce the current pulse. Further, such a laser device can be made very compact, with the high power transmission line circuit configuration for the excitation of the laser. For example, such a laser could have a dimension of only about 0.4 meters×0.4 meters by about 1 meter, excluding the power supply. The small volume is an important feature, as it allows the lazing device to be placed on top of a small table, i.e., such a soft x-ray laser can be referred to as a “table top” soft x-ray laser.

As mentioned above, other embodiments can use electron ion recombination. In electron ion recombination, a laser created plasma rapidly cools at the end of the excitation pulse by adiabatic expansion, radiation, or electron heat induction. The rapid decrease in the plasma temperature causes the electrons and ions in the plasma to recombine, creating population inversion between excited levels of the lesser charged ions that result from the recombination process. Again radiation with a photon energy corresponding to the energy difference between the inverted levels is amplified. Embodiments that use electron ion recombination can also be made in a table top configuration.

Due to the wavelength of the soft x-ray laser being produced by soft x-ray laser 202, e.g. 40-50 nm, optic 204 can comprise a free standing zone plate. For example, zone plate 204 can comprise a zone plate transmission efficiency of 10%, an outermost delta (r) at 200 nanometers, 625 zones, a diameter of 500 microns, a focal length of 2.1 millimeters, an S number of 7.42, and a spectral resolution (Delta Lambda/Lambda) of 0.0016. Such a zone plate has been fabricated by the center for x-ray optics (CXRO) at the Lawrence Berkeley National Laboratory (LBNL) in Berkeley, Calif.

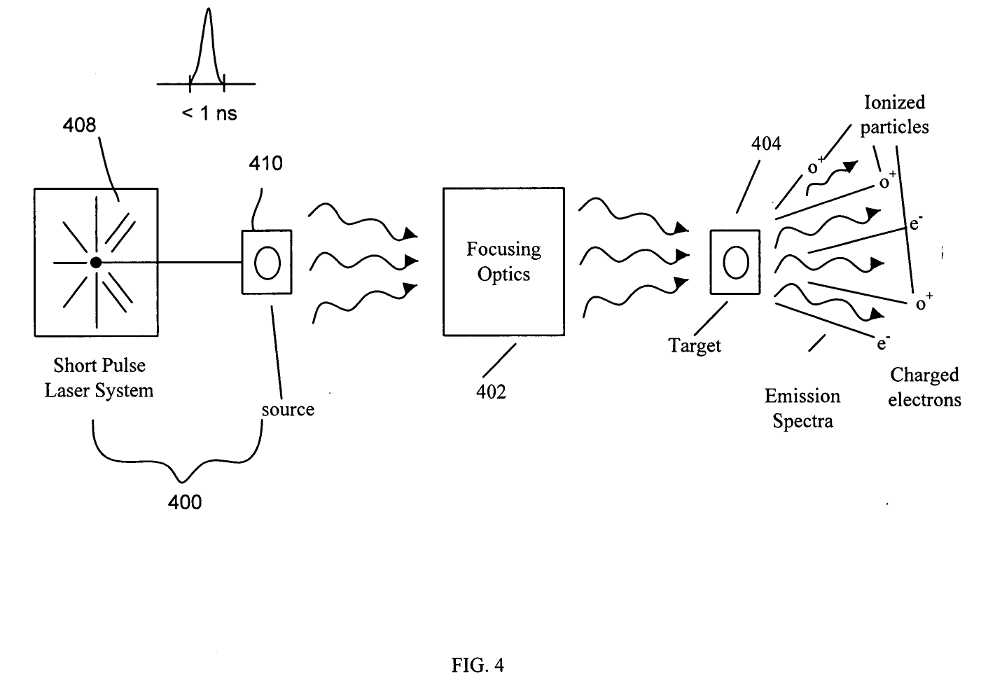

As mentioned above, other embodiments of system 100 can use laser induced plasmas for emissions source 102. FIGS. 4-8 are diagrams illustrating example embodiments of systems configured to perform nanoscale surface analysis of a sample that uses laser produced plasmas for the emissions source. For example, in the arrangement shown in FIG. 4, emissions source 400 includes a laser system 408 as an energy source and a target material 410 as a radiation source. Preferably, emissions source 400 is sufficient to deliver enough power per unit area when focused to a very small spot size, for example having a diameter of 50 nm or less, to ablate target sample 404 and form a nanoplasma. Preferably, emissions source 400 serves as a source for short wavelength radiation. Desirable wavelengths can be those associated with x-rays, including soft x-rays, for example having a wavelength in the range of 1-15 nm. High-intensity laser irradiation of target material 410 can generate an x-ray point source. For instance, x-rays can be produced by focusing ˜10¹⁵ W/cm² of 1.06μ of light onto a thin Copper (Cu) tape. In another preferred embodiment, target material 410 can be constructed of Mylar, such as a Mylar foil (C₁₀H₈O₄), where the carbon emission is 3.37 nm.

Although target material 410 can therefore be formed from any desired material that emits radiation of a desired wavelength when irradiated by an appropriate energy source, it is preferable that target material 410 be such that it emits short-wavelength radiation when illuminated by a pulse from laser system 408. For example, using a laser to induce, Copper (Cu) emits ˜1.1 keV x-rays, Nickel (Ni) emits ˜1.0 keV x-rays, Zinc (Zn) emits ˜1.2 keV x-rays, Gallium (Ga) emits ˜1.3 keV x-rays, Germanium (Ge) emits ˜1.4 keV x-rays, Indium (In) emits ˜4 keV x-rays, and Tin (Sn) emits ˜4 keV x-rays. By irradiating at higher laser intensities, emissions can be induced from Beryllium (Be) (˜0.1 keV), Boron (B) (˜0.2 keV), Carbon (C) (˜0.3 keV), Chlorine (Cl) compounds (˜2.8 keV), Titanium (Ti) (˜4.8 keV), Gallium (Ga) (˜10 keV), and Indium (In) (˜29 keV). It will be appreciated that other emissions at different energy levels can also be induced.

Preferably, emissions source 400 serves as a soft x-ray generator, capable of generating x-ray emissions, including those having a wavelength in the range of 1-15 nm. To accomplish this, examples of suitable laser systems for use as laser system 408 include the BriteLight™ laser available from JMAR Technologies, Inc. of San Diego, Calif., and laser systems described in U.S. Pat. Nos. 5,434,875; 5,491,707; and 5,790,574, all of which are hereby incorporated by reference into this description. In a preferred embodiment, laser system 408 can include a master oscillator (MO) and an amplifier, where the MO is a Nd:YAG rod longitudinally pumped by a diode array with micro-lenses. The MO resonator has several optical elements to produce an output of 1 mJ/pulse at 1000 Hz with <1 ns pulse duration and near-diffraction limited beam quality. The amplifier can be a diode-pumped amplifier that increases the pulse energy, for example to an amount>50 mJ at 300 Hz providing for 15 W average power. Additional amplifiers can be included to obtain over 75 W. Further examples of x-ray sources suitable for use as emission source 400 are described in U.S. Pat. Nos. 5,089,711 and 5,539,764, which are both hereby incorporated by reference into this description.

Target material 404 can be in the form of a solid block; however, other forms can be used. For example, one embodiment of target material can be that of a tape or ribbon, for example as disclosed in U.S. Pat. No. 5,539,764, which is hereby incorporated by reference. The tape or ribbon can be a roll of target tape, where the tape is one-half inch in width and approximately 10-20 microns thick. The roll of target tape can be dispensed at a predetermined rate while a laser beam pulse from laser system 408 irradiates the tape at a desired frequency. The fast ions ablated from target material 410 are ejected away from the target. The plasma-generated shock wave breaks through the tape and ejects most of target material 410 to a location where it can be collected. Thus, the use of target material in the form of a tape substantially reduces ion contamination of other system components when compared with solid blocks of target material.

In order to further reduce material contamination, a filtering gas can be circulated in the vicinity of target material 410. For example, it is preferable to use nitrogen as a filtering gas for the case where a Mylar target is used. In other embodiments, such as where a copper tape target is used, Helium can be used as a filtering gas. If target material 410 is located within an x-ray chamber, the x-ray chamber can be filled with a filtering gas. For example, where He gas is used in conjunction with a Cu target, He flow at 50 torr can be used with a shroud to reduce or stop contamination. As the filtering gas is circulated within the x-ray chamber it removes the ablated ions. As ions are ablated from the target material, atoms of the filtering gas collide with the high-velocity ions, stopping the ions within a few centimeters from the target position. As the gas/ion mixture is re-circulated within the x-ray chamber, filters can be used to trap the ions, recirculating only the filtering gas at the completion of the filtration process. The use of thin tape targets and helium gas to stop ablated ions from contaminating the x-ray chamber is described in more detail in Turcu, et al., High Power X-ray Point Source For Next Generation Lithography, Proc. SPIE, vol. 3767, pp. 21-32, (1999), which is hereby incorporated by reference.

Alternately, target material 410 can be provided in other preferable forms. For example, target material 410 can be in the form of a liquid droplet or a solid pellet, such as those described in pending U.S. patent application Ser. No. 09/699,142 (referred to hereinafter as the '142 application), which is hereby incorporated by reference. Preferably the pellets or droplets are substantially spherical with a diameter less than 1 cm, such as in a range of 10 to 100 microns, and free of any surface contaminants, debris, or irregularities. The droplets or pellets can be provided by a dispensing apparatus that dispenses droplets or pellets into the path of laser pulses emitted by laser source 408. The '142 application describes many different types of dispensing apparatuses that can be incorporated into emission system 400, particularly where droplet or pellet target materials are used.

Another option for target material 410 can be a membrane as described in U.S. patent application Ser. No. 10/750,022, which is hereby incorporated by reference. The preferred thickness of the target membrane is in the range of about 0.1 μm to about 100 μm. Some embodiments can utilize a supporting aperture in which the membrane is formed and irradiated with a laser pulse from laser source 408. In other embodiments, target material 410 can be a spherical membrane, similar to a bubble. Preferrably, the spherical membrane will encase a gas that is of a low atomic number. Although the gas ideally comprises hydrogen, the reactivity of hydrogen gas makes it preferable to select inert gas, such as helium. Gasses with a lower atomic number are preferred because of their lower absorption of short-wavelength radiation. The membrane can be a molten material, for example tin, with good wetting properties to ensure that the molten material has sufficient surface tension to form a membrane in the aperture. Other embodiments can utilize a solution comprising a mixture of metallic compounds such as tin chloride (SnCl₂), zinc chloride (ZnCl), tin oxide (SnO₂), lithium (Li), a tin/lead mixture (Sn/Pb), and iodine (I), in a solvent such as water. Utilizing these solutions eliminates the requirement of maintaining the reservoir of target material above the melting point of a target material, such as tin (231° C.). In order to provide soft x-rays (˜3-5 nm), carbon-based membrane targets can be utilized. Examples of solutions comprising carbon-based microtargets include plastics, oils, and other fluid hydrocarbons.

Finally, another option for target material 410 is to use a liquid target, where the liquid can be delivered using a liquid jet system. For example, a Xenon based liquid jet system can be used to provide radiation have a wavelength of ˜11 nm. It should be noted that ice or solid xenon can also be used to emit soft x-rays. Examples of ice targets include a thin sheet or cylindrical block of ice. The ice preferably is cooled by a heat pump, such as including liquid nitrogen reservoir placed in proximity to or in contact with the ice. In the case where a liquid target is provided, the liquid can be treated with additives such as zinc chloride, to adjust the emission spectrum. Likewise, the solid component may be increased in this stream to the point where the stream comprises solid micropellets or clusters. For example, micropellets of tin or other suitable substances may be provided via a nozzle in a fluid (gas or liquid) stream.

It should be understood that the above-mentioned particular laser sources and x-ray sources are mentioned as examples and any x-ray source generating a sufficient x-ray brightness (i.e. photons per unit area, per unit time, per unit of solid angle) can be used.

Emissions optical system 402, and more broadly optical system 106, serves primarily to collect emissions from emissions source 400 and direct them to target sample 404. In a preferred embodiment, emissions optical system 402 is designed to collect soft x-rays emitted from emissions source 400 and focus them to a spot having a diameter less than 50 nm, such as in a range of 10-30 nm. Emissions optical system 402 can be a static system, designed to be focused at a fixed point, in which case target sample 404 can be controllably positioned as discussed below.

It will be appreciated that the optical design of emissions optics 402, and more broadly optic system 106, is dependent upon several factors, including the wavelength of emissions from emissions source 400. It will also be appreciated that optical elements are aligned as necessary to control the path of x-rays from emissions source 400 to target sample 404, or from target sample 404 to analysis instrumentation 406. Since soft x-rays do not pass through most materials, x-ray optics using either diffractive effects, grazing incidence reflection, or multilayer Bragg reflection can generally be used. For systems with longer wavelengths, such as >8 nm, Bragg multilayer coatings can be made that have high reflectivity over large collection angles. For shorter wavelengths, grazing incidence or diffractive optics are generally most effective.

Specific examples of optical designs for emissions optics 402 are provided in the descriptions below. However, it will be appreciated that the embodiments described below are provided only as examples and, as such, are not intended to be limiting. Rather, it will be apparent to those skilled in the art that other arrangements are possible, including variations of the arrangement and characteristic of elements of the optical design examples provided below.

Target sample 106 is a material undergoing analysis in the case of embodiments in which spectroscopy is being performed. In other embodiments, target sample 106 can be representative of an article playing some alternate role in the overall system. For example, the system in FIG. 4 can be used for nanomachining or vapor deposition applications, in which case target sample 404 can be a substrate, such as a wafer, being machined or having layers built thereupon. For spectroscopy applications, target sample 106 can be a nanoscale material having variations, such as chemical or surface variations, that occur on the nanometer scale. In order to study such variations, emissions system 102 and emissions optical system 106 preferably irradiate the target sample such that sample spatial resolutions less than 200 nm are possible, for example in a range of 20-200 nm.

In order to address various portions of the target sample 106 a fine-positioning system can be employed. Preferably, the positioning system provides for resolution in increments less than 200 nm or as small as possible, for example 10 nm. In a preferred embodiment, a piezoelectric motioning system can be used. High resolution positioning stages having the capability of moving target sample 106 in the required increments are commercially available and can be obtained from, for example, Physik Instrumente GmbH & Co., Polytec Platz 1-7, 76337 Waldbronn, Germany. Piezoelectric stages available from this company can provide movements on the nanometer scale along multiple axes.

The systems and methods described above can be used in a variety of different applications, including failure analysis, process control and design applications. For example, in certain embodiments, emission source 102 can be configured to emit self x-rays that are used to form a nanoplasma on target sample 106. Radiation from nanoplasma can then be analyzed using spectrometer as analysis equipment 108. For example, the spectrometer can be a photometric analyzer for analyzing material chemical compositions via soft x-ray to infrared (1R) radiation. The spectrometer can also be a MS-TOF Analyzer for analyzing material chemical compositions via mass of ions emitted from the nanoplasma. The spectrometer can also be a photoelectron analyzer for analyzing the material surface chemicals. In other embodiment, emission source 102 can emit x-rays having 300-500 eV, and a Charged Couple Device (CCD) camera can be used as analysis instrumentation 108. That such embodiments, System 100 can serve as an x-ray transmission microscope for imaging nano scale objects, for example, biological cells or polymer structures.

Further, over the past 30-40 years, a wide range of surface and micro analytical techniques have evolved. Each technique has its own capabilities that are related to the particular physical interaction involved with that technique. The systems and methods described above can be used to perform many of these techniques. For example, the systems and methods described above can be used to perform AUGER Electron Spectroscopy (AES), total reflection X-ray Fluorescence (TXRF), Time of Flight secondary Ion Mass Spectrometry (TLF-SIMS), X-ray Photoelectrons Spectroscopy/Electrons Spectroscopy for chemical analysis (XPS-ESCA), X-ray Diffraction (XRD), and Secondary Ion Mass Spectrometry (SIMS).

The system shown in FIG. 1 can also be used for numerous applications other than those discussed associated with spectroscopy. For example, embodiments of the system shown in FIG. 1 can include systems for nanomachining—performing material removal at nanometer levels—where x-rays emitted from emissions source 102 form a nanoplasma on target sample 106, thereby ablating a portion of the material. The position of target sample 106 can be varied and emissions from the emissions source 102 can be controlled so that material of target sample 106 is selectively ablated, allowing nanoscale patterns to be formed in target sample 106. Thus, nanostructures can be constructed with a high level of precision. Nanomachining can include the repair of defects in semiconductor devices. Nanomachining can be used to provide for the precise and accurate removal of defects in quartz, chrome, MoSi, and various other materials. The system shown in FIG. 1 can provide for nanomachining with resolution less than 200 nm, for example 30-50 nm.

Further embodiments include those where the system shown in FIG. 1 is used for epitaxy or film deposition processes. For example, the system shown in FIG. 1 can be a system for performing plasma/photo enhanced vapor deposition, e.g., Plasma Enhanced Chemical Vapor Deposition (PECVD) processing. In general, Chemical Vapor Deposition (CVD) is a process where gas molecules (precursor) are transformed into solid thin-film or powder material on the surface of a substrate, such as a wafer. In a PECVD system, a plasma is used to decompose a reactant gas and deposit the reaction products onto a substrate surface. For example, as a reactant silane (SiH₄) can be decomposed into Si and SiH radicals, where the silicon precipitates on the surface of the substrate as a new layer. There are numerous reactants and materials that can be deposited via PECVD processing known to those skilled in the art, including conductors such as tungsten, copper, aluminum, transition-metal silicides, and refractory metals, semiconductors such as gallium arsenide, epitaxial and polycrystalline silicon, and dielectrics such as silicon oxide, silicon nitride, and silicon oxynitride.

In some embodiments of the system shown in FIG. 1, localized deposition systems can be realized where deposition is controlled to be confined to specific areas on the surface of target sample 106 rather than uniformly spread over the entire surface. For example, the system shown in FIG. 1 can be a localized PECVD system where a nanoplasma can be formed on a surface of target sample 106. Reactive gases can be circulated over the surface of the target sample 106. As the nanoplasma reacts with the reactive gases, deposition occurs on the surface of target sample 106. However, since the nanoplasma is confined to a very small area, for example an area <200 nm such as in a range of 30-50 nm or even smaller, volatilization of the reactive gases occurs only in the nanoplasma region of the surface of target sample 106. Thus, deposition is limited to the region of target sample 106 in the vicinity of the nanoplasma. As a result, a highly-localized PECVD process can be realized where a film can be deposited in a highly controlled, spatially-confined manner, particularly as compared with other PECVD processes.

It will be appreciated by those skilled in the art that similar embodiments of the system shown in FIG. 1 can include systems for performing plasma enhanced OrganoMetallic Chemical Vapor Deposition (OMCVD) or plasma enhanced OrganoMetallic Vapor Phase Epitaxy (OMVPE), which involve the use of organometallic precursors.

It will be apparent that there are numerous embodiments contemplated for the presently disclosed system. Select embodiments will now be described, however it will be appreciated that these embodiments are not intended to be limiting in any way.

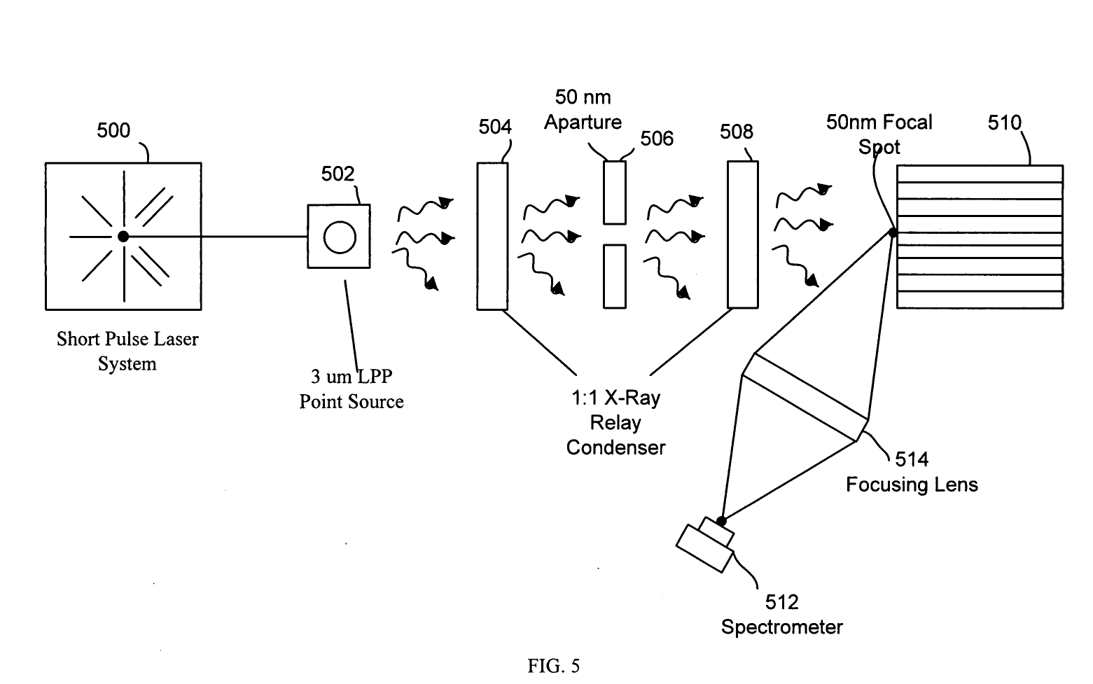

A first exemplary embodiment will now be discussed in connection with FIG. 5. The system shown in FIG. 5 is an example of a laser-produced plasma x-ray nanoplasma spectroscopy system (LPP-XNS). In this embodiment, the emissions source is embodied as a short-pulse laser system 500 and a target source 502. Target source 502 is preferably constructed of copper (Cu) and provided in the form of a tape or ribbon. Helium gas is circulated in the vicinity of target source 502 for debris mitigation, thereby reducing contamination of system components. Laser source 500 preferably emits laser energy at 250 mJ/pulse having a pulsewidth of 800 ps at 300 Hz repetition. Other high-energy pulses are suitable, as long as they have sufficient energy to form a plasma at target source 502. This laser energy is directed at target source 502 to produce a plasma that serves as a 3 μm x-ray point source. An example of a suitable laser for laser system 500 includes a diode-pumped Nd:YAG laser such as those discussed above. With this arrangement, a plasma can be produced on target source 502 when irradiated by a laser pulse emitted by laser system 500. The plasma thus produced emits x-ray radiation having a wavelength in the range of 1-8 nm, such as 3 nm.

The emissions optical system is embodied as a relay optical system that includes a first x-ray relay condenser 504, an aperture 506, and a second x-ray relay condenser 508. Aperture 506 can be a mask having an aperture diameter selected according to the x-ray wavelength and the desired size of the focal spot. In general, physics imposes a limit on the smallest size of the focal spot of about 1.22× the wavelength of the radiation. Thus, exemplary apertures can have a diameter of 30 nm, or, for example, any diameter less than 200 nm, or any diameter in a range of 20-200 nm or 30-100 nm, such as 50 μm. In a preferred embodiment, first and second condensers 504 and 506 are 1:1 condenser elements such as a Fresnel zone plate or order sorting aperatures. A Fresnel zone plate has alternating transparent and opaque zones in the form of concentric rings that result in a binary amplitude diffractive optic element that can be used as a lens. By blocking every other zone, planar light passing through the plate will constructively interfere at a focal point of the zone plate. First and second condensers 504 and 506 can be, for example, zone plates where each zone plate has a zone plate transmission efficiency of 10%, an outermost delta r of 25 nm, 625 zones, a diameter of 62.5 μm, a focal length of 463.65 μm, an f-number of 7.42, and a spectral resolution (delta lambda/lambda) of 0.0016. Such zone plates have been fabricated by the Center for X-Ray Optics (CXRO) at the Lawrence Berkeley National Laboratory (LBNL) in Berkeley, Calif.

In the embodiment shown in FIG. 5, target sample 510 is a nanomaterial with varied chemical composition on a nanometer scale, for example on a 50 nm length scale. Using the emissions system and emissions optics described above for the present embodiment, x-rays emitted from target source 502 can be focused to achieve a focal spot having a small diameter and a high power density on target sample 510. As a result, a nanoplasma can be formed having temperature is about 10⁵ K. In the present embodiment, the spectrum (blackbody) of emissions from the plasma can be collected and evaluated using a conventional light gathering spectrometer 512. A f/3 collection optic 214 can be used to deliver approximately 10⁸ photons/second to the spectrometer. If, for example, spectrometer 512 uses a 1024 linear array and is only 10% efficient, this would provide for collection of about 10⁴ photons/pixel/second, for a one second integration this would provide for a SNR of about 100 on each pixel. As an alternative, this embodiment can include a time of flight mass spectrometer to collect ions sputtered from the nanoplasma location and obtain additional information about target sample 510. In some embodiments, the power density can be reduced such that a nanoflourescent spot is formed on target sample 510 rather than a nanoplasma. The spectrometer is suitable for analyzing the nanoflourescent emissions as well.

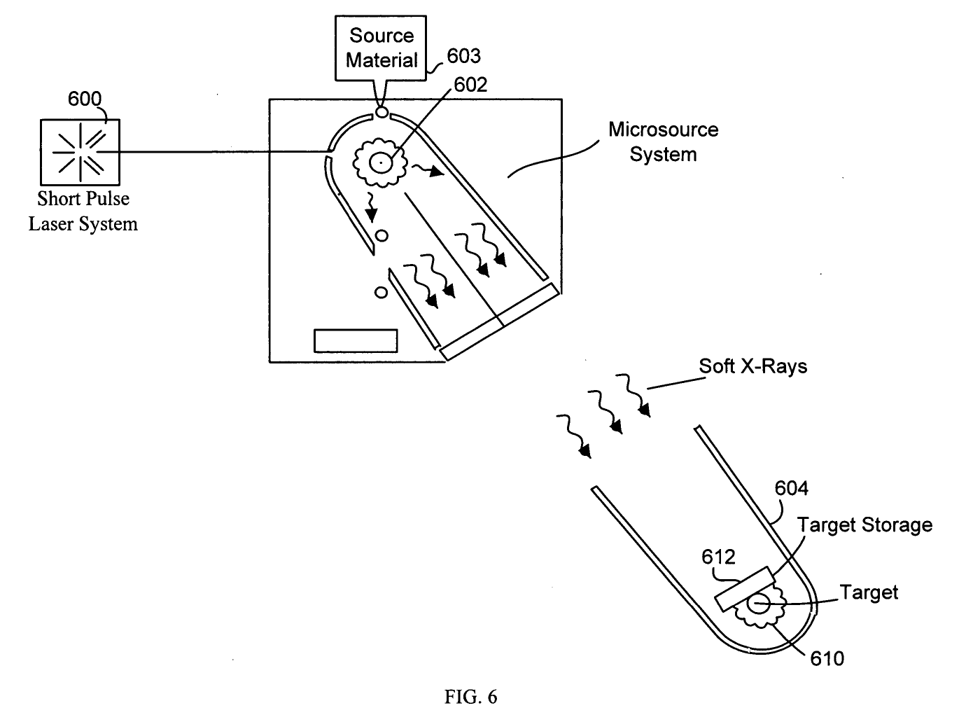

A second exemplary embodiment will now be discussed in connection with FIG. 6. The system shown in FIG. 6 is another example of a laser-produced plasma x-ray nanoplasma spectroscopy system (LPP-XNS). In general, the system shown in FIG. 5 is best suited for shorter x-ray wavelengths, for example 2-nm. The present embodiment shown in FIG. 3 is better suited for longer x-ray wavelengths, for example >8 nm. In this embodiment, the emissions source is embodied as a short-pulse laser system 600 and a target source 602. Target source 602 preferably comprises xenon (Xe) and is provided in the form of a liquid jet; however, it will be appreciated that other target materials and/or forms of material can be used. Target source 602 is provided by a source material reservoir 303 and a jet apparatus. Laser source 600 preferably emits laser energy at 250 mJ/pulse having a pulsewidth of 800 ps at 300 Hz repetition. Other high-energy pulses are suitable, as long as they have sufficient energy to form a plasma at target source 602. This laser energy is directed at target source 602 to produce a plasma that serves as a 5 μm x-ray point source. An example of a suitable laser for laser system 600 includes a diode-pumped Nd:YAG laser such as those discussed above. With this arrangement, a plasma can be produced on target source 602 when irradiated by a laser pulse emitted by laser system 600. The plasma thus produced emits x-ray radiation having a wavelength of >8 nm, such as 11 nm. Other examples of acceptable target delivery systems include the microtarget systems described in U.S. patent application Ser. No. 09/699,142 entitled “Radiation Generating System Using Microtargets and Method for Using Same,” which is hereby incorporated by reference into this specification.

The emissions optical system is embodied as a parabolic condenser 604. In a preferred embodiment, parabolic condenser 604 is embodied as a parabolic multilayer mirror. Parabolic condenser 604 can be, for example, a parabolic multilayer mirror, such as a focusing multilayer optic commercially available from Osmic, Inc., of Auburn Hills, Mich.

In the embodiment shown in FIG. 6, a target sample 610 is supported by a 6-axis piezoelectric positioning stage 612 having 10 nm resolution. Using the emissions system and emissions optics described above for the present embodiment, x-rays emitted from target source 602 can be focused to achieve a focal spot having a diameter of 50 nm with an ablation power on the 50 nm spot of 0.2 W. For Ins pulse duration, ablation energy per pulse is 0.2 W×1 ns=0.2 nJ on the 50 nm spot. The laser system outputs 250 mJ/pulse at 300 Hz at Xe target source 602 to produce soft x-rays having a wavelength of 11 nm-15 nm and a conversion efficiency of ˜3% into 2πsr to yield soft x-ray (or EUV) power of 7.5 mJ. In this case, the x-ray energy into 0.1 msr=12 nJ and, for a mirror 604 having reflecting power R=0.6, the x-ray energy after reflection is 7.2 nJ, which is provided to the 50 nm spot on target sample 610. This results in a nanoplasma ablation energy of 3×10¹¹ W/cm² or greater. At a lower repetition rate for the laser (˜10 Hz) the energy/pulse can be increased by another order of magnitude (>2 J/pulse) to yield 3×10¹² W/cm² or greater. Since the power density in this embodiment is similar to that of Embodiment I, the photon budget to a spectrometer would be similar or the same.

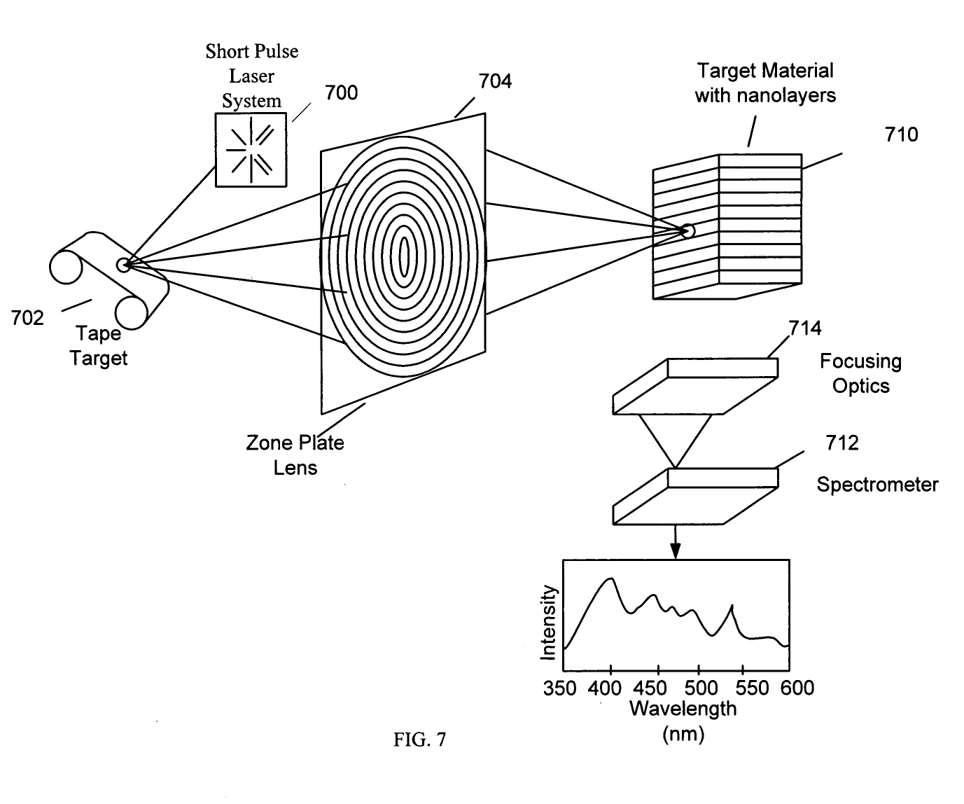

A third exemplary embodiment will now be discussed in connection with FIG. 7. The system shown in FIG. 7 is a further example of a laser-produced plasma x-ray nanoplasma spectroscopy system (LPP-XNS). In this embodiment, the emissions source is identical to that of Embodiment I discussed above, including a short-pulse laser system 700 and a copper target source 702 in the form of a tape or ribbon.

The emissions optical system is embodied as a relay optical system that includes a single x-ray relay condenser 704 which receives x-ray emissions from target source 702 and refocuses the x-rays at a focal spot on a target sample 710. In a preferred embodiment, condenser 704 is a Fresnel zone plate such as described above in connection with Embodiment I. Thus, the present embodiment differs from Embodiment I in that aperture 506 and second condenser 508 are omitted in the present embodiment.

Further elements of the present embodiment can include a spectrometer 712 and collection optic 714 as discussed above in connection with Embodiment I.

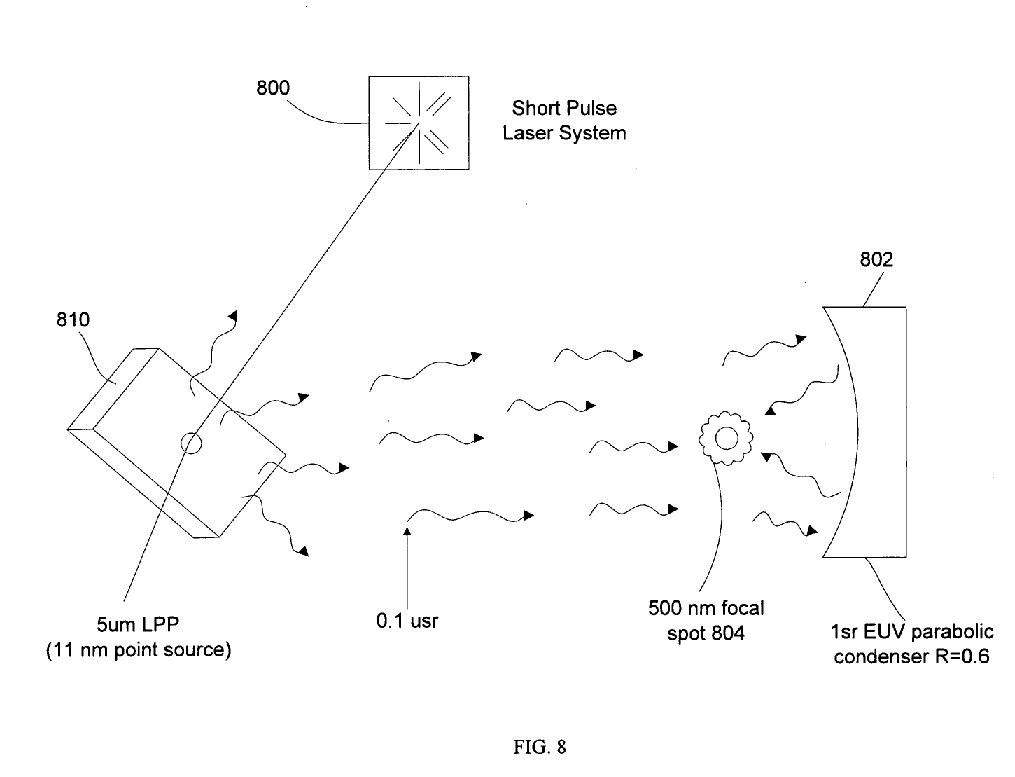

A fourth exemplary embodiment will now be discussed in connection with FIG. 8. The system shown in FIG. 8 is a further example of a laser-produced plasma x-ray nanoplasma spectroscopy system (LPP-XNS). In this embodiment, the emissions source is identical to that of Embodiment I discussed above, including a short-pulse laser system 800 and a target source 802.

The emissions optical system is embodied as a 1 sr EUV parabolic reflective condenser, which receives x-ray emissions from target source 810 and reflects the x-rays at a focal spot onto a focal spot 804. In a preferred embodiment, reflector 802 is a parabolic condenser with an R=0.6. Further elements of the present embodiment can include a spectrometer and collection optic as discussed above in connection with Embodiment I.

Still further embodiments incorporating systems and methods described above are contemplated. For example, it is contemplated that hybrid systems could be realized that incorporate several concepts discussed above. One such embodiment could be a system that is useful for a combination of one or more types of spectroscopy (e.g., light-gathering, time-of-flight, and/or electron spectroscopy) and/or one or more other applications including a nanomachining and/or a nano-deposition process. Such a system could be equipped with an emissions source that can be adjusted to control the power supplied to the target sample in accordance with the different requirements associated with different processes. For example, in a hybrid nanomachining/spectroscopy system the emissions system can be controlled (e.g., by adjustment of laser pulse energy or pulse frequency of the laser system 108 and/or changing the material used for the target material 110) such that the power can be increased to create a nanoplasma on the sample for a nanomachining process, then decreased to create a non-ablating nanofluorescent spot for a chemical analysis process.

Other possible applications of this invention include an x-ray transmission microscope and a photoelectron analyzer. According to these embodiments, a short pulse laser system with a less powerful amplifier is preferred. In addition, other radiation sources can be utilized to generate x-rays or soft x-rays of the desired wavelength. For the x-ray transmission microscope embodiment, the target would comprise a micro-size or nano-size sample to be imaged. The x-rays transmitted through or reflected by the sample could be collected by a CCD array to generate an image of the sample, or an image of a desired polymer structure. This device would have the advantage of a resolution in the range of 20 nm-200 nm. For the photoelectron analyzer, a nanoplasma or nanoflourescent spot could be formed on the target material with sufficient energy to eject electrons from the target. Materials analysis could be conducted by analyzing the energy of the ejected electrons.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. A nano-scale surface analysis system, comprising:
a emissions source configured to emit short-wavelength radiation; and
a focusing optic for receiving the short-wavelength radiation from the emissions source and focus the radiation onto a target, the radiation being focused onto an area of the target having a diameter of less than 200 nm.

2. The nano-scale surface analysis system of claim 1, wherein the emissions source comprises a short-pulse laser system for generating a laser pulse having an energy density sufficient to form a point plasma at a short-wavelength radiation source, wherein the radiation source emits short-wavelength radiation from the point plasma when illuminated by the laser pulse.

3. The nano-scale surface analysis system of claim 1, wherein the emissions source comprises an electrical powered apparatus for the generation of soft x-ray laser radiation.

4. The nano-scale surface analysis system of claim 3, wherein the apparatus comprises an excitation circuit having at least two or more electrically conducting structures separated by a liquid dielectric for providing a high current excitation pulse.

5. The nano-scale surface analysis system of claim 4, wherein the apparatus further comprises a capillary structure having a capillary with a length to diameter ration of about 20 to 1000 for enclosing a selected lasing material, wherein the excitation circuit is capable of generating a plasma volume within the capillary structure to produce a population inversion.

6. The nano-scale surface analysis system of claim 5, wherein the apparatus further comprises a circuit configured to pre-ionize the selected lasing material prior to the fast high current excitation pulse.

7. The nano-scale surface analysis system of claim 1, wherein the short-wavelength radiation has a wavelength in a range of 1 nm to 15 nm.

8. The nano-scale surface analysis system of claim 7, wherein the short-wavelength radiation has a wavelength greater than 8 nm.

9. The nano-scale surface analysis system of claim 1, wherein the soft x-ray radiation has a wavelength in a range of 40-50 nanometers, e.g., approximately.

10. The nano-scale surface analysis system of claim 9, wherein the soft x-ray radiation has a wavelength of approximately 46.9 nanometers.

11. The nano-scale surface analysis system of claim 1, wherein said focusing optic includes Bragg multilayer coatings.

12. The nano-scale surface analysis system of claim 1, wherein said focusing optic includes at least one of a grazing incidence optical element or a diffractive optical element.

13. The nano-scale surface analysis system of claim 1, wherein the focusing optic is for focusing the radiation onto an area of the target having a diameter less than 100 nm.

14. The nano-scale surface analysis system of claim 1, further comprising a positioning stage for positioning the target.

15. A nano-scale surface analysis system, comprising:
an electrical powered apparatus for the generation of soft x-ray laser radiation, the apparatus comprising:
an excitation circuit having at least two or more electrically conducting structures separated by a liquid dielectric for providing a high current excitation pulse, and
a capillary structure having a capillary with a length to diameter ration of about 20 to 1000 for enclosing a selected lasing material, wherein the excitation circuit is capable of generating a plasma volume within the capillary structure to produce a population inversion; and
a focusing optic for receiving the soft x-ray radiation from the emissions source and focus the soft x-ray radiation onto a target, the soft x-ray radiation being focused onto an area of the target having a diameter of less than 100 nm.

16. The nano-scale surface analysis system of claim 15, wherein the apparatus further comprises a circuit configured to pre-ionize the selected lasing material prior to the fast high current excitation pulse.

17. The nano-scale surface analysis system of claim 15, wherein the soft x-ray radiation has a wavelength in a range of 40-50 nanometers, e.g., approximately.

18. The nano-scale surface analysis system of claim 17, wherein the soft x-ray radiation has a wavelength of approximately 46.9 nanometers.

19. The nano-scale surface analysis system of claim 15, wherein the focusing optic comprises a free standing zone plate.

20. The nano-scale surface analysis system of claim 19, wherein the free standing zone plate comprises a zone plate transmission efficiency of 10%.

21. The nano-scale surface analysis system of claim 19, wherein the free standing zone plate comprises an outermost delta (r) at 200 nanometers.

22. The nano-scale surface analysis system of claim 19, wherein the free standing zone plate comprises 625 zones.

23. The nano-scale surface analysis system of claim 19, wherein the free standing zone plate comprises a diameter of 500 microns.

24. The nano-scale surface analysis system of claim 19, wherein the free standing zone plate comprises a focal length of 2.1 millimeters.

25. The nano-scale surface analysis system of claim 19, wherein the free standing zone plate comprises an F number of 4.2.

26. The nano-scale surface analysis system of claim 19, wherein the free standing zone plate comprises a spectral resolution (Delta Lambda/Lambda) of 0.0016.
